(19) United States
(12) Patent Application Publication
(10) Pub. No.: US 2025/0198167 A1
(43) Pub. Date: Jun. 19, 2025

(54) GYPSUM FILLER BASED JOINT COMPOUND WITH LOW COEFFICIENT OF FRICTION

(71) Applicant: United States Gypsum Company, Chicago, IL (US)

(72) Inventors: David Daniel Pelot, Chicago, IL (US); Tyler Jared Kincaid, Wheaton, IL (US); Phanindra Kodali, Mundelein, IL (US); Scott Daryl Cimaglio, Grayslake, IL (US); Naveen Punati, Kildeer, IL (US)

(21) Appl. No.: 18/804,284

(22) Filed: Aug. 14, 2024

Related U.S. Application Data
(60) Provisional application No. 63/609,437, filed on Dec. 13, 2023.

(51) Int. Cl. E04F 13/08; C04B 14/36; C04B 26/22; C04B 111/00

(52) U.S. Cl. CPC E04F 13/0891; C04B 14/365; C04B 26/22; C04B 2111/00681

(57) ABSTRACT

A drying-type joint compound and related methods, the drying-type joint compound having a lowered friction coefficient and formulated with gypsum powder having the median particle size (D50) of at least about 20 μm, preferably the gypsum powder has a D10 greater than 5 μm, wherein the drying-type joint compound further comprises a binder; one or more clays; a cellulosic thickener; and an additive.

### CROSS-REFERENCE TO RELATED APPLICATIONS

This application claims the benefit of prioirty from U.S. Provisional Patent Application 63/609,437 filed Dec. 13, 2023, the entire disclosure of which is herein incorporated by reference in its entirety.

### TECHNICAL FIELD

This disclosure relates to the field of building construction compositions and methods, including drying-type joint compounds having a lowered friction coefficient.

### BACKGROUND

Gypsum panels including drywall panels are commonly used in construction of interior walls and ceilings. In order to build a wall, gypsum panels may be affixed to a frame with fasteners. Various joint compounds are then used in order to finish seams (joints) between adjacent gypsum panels.

Joint compounds include setting-type joint compounds which comprise calcined gypsum as a main filler and drying-type joint compounds which may comprise calcium carbonate as a main filler. A joint compound is mixed with water to form a paste which is then spread over a drywall surface and joints. After the applied joint compound dries, it may need to be sanded.

Various attempts have been made to improve sandability of a joint compound. For example, U.S. Pat. No. 10,928,286 discloses a system and method for determining a sandability value of a joint compound. U.S. Pat. No. 7,048,791 discloses a low dust wall repair compound which comprises one or more of airborne dust reducing additives including oils, surfactants, solvents, waxes, and other petroleum derivatives. U.S. Pat. Nos. 10,800,706 and 10,988,416 disclose vesicle dedusting agents for joint compounds and methods.

Yet, there remains the need in the field for drying type joint compounds that would be relatively easy to sand.

### SUMMARY

In one aspect, this disclosure provides drying-type joint compounds formulated with gypsum powder having the median particle size (D50) of at least about 20 μm as measured with a dynamic light scattering analyzer. These drying-type joint compounds have a technical advantage of a lowered friction coefficient in comparison to drying-type joint compounds formulated with gypsum having the median particle size (D50) of about 15 μm.

In one aspect, this disclosure provides a drying-type joint compound composition comprising:
a) gypsum powder having the median particle size (D50) of at least about 20 μm or greater;
b) a binder;
c) one or more clays;
d) a cellulosic thickener; and
e) an additive.

The drying-type joint compound composition when mixed with water and allowed to dry has a friction coefficient lower than a friction coefficient of a drying-type joint compound comprising gypsum having the median particle size (D50) of about 15 μm.

Preferably, the drying-type joint compound compositions include those, wherein the gypsum powder has a D10 value equal or greater than 5 μm.

In some embodiments of the drying-type joint compound composition, the gypsum powder may be produced in a method which comprises removing fine particles, including those that are smaller than 5 μm from the gypsum powder.

In some embodiments, the gypsum powder may have the D50 value in the range from about 20 μm to about 80 μm. In some embodiments of the drying-type joint compound composition, the additive may include a polymeric additive selected from one or more of the following: a surfactant, redispersible powdered latex, dispersing agent, humectant, defoaming agent, a plasticizer, polyethylene oxide, a phospholipid, or any combination thereof.

The drying-type joint compound compositions according to this disclosure include those, wherein the gypsum powder may be used in an amount ranging from about 50 wt % to about 95 wt % on a dry basis of the drying-type joint compound composition. In other embodiments, the drying-type joint compound compositions according to this disclosure include those, wherein the gypsum powder is used in a combination with calcium carbonate, the combination comprising from about 50 wt % to about 95 wt % on a dry basis of the dry-type joint compound composition; and calcium carbonate to fractionated gypsum being used in a ratio ranging from 1:10 to 10:1 by weight.

In some embodiments of the drying-type joint compound composition, the gypsum powder may be supplied as fractionated gypsum powder from which fine particles have been removed such that the gypsum powder does not comprise or comprises only less than 10% of fine particles which are smaller than 5 μm.

The drying-type joint compound compositions according to this disclosure include those, wherein the gypsum powder being fractioned in a method which comprises: separating gypsum particles according to their sizes in a turbine, with a whizzer air separator, a cyclone, an elbow jet air classifier and/or passing the gypsum powder through a U.S. 625 Mesh and collecting a gypsum fraction retained on the U.S. 625 Mesh, the retained gypsum fraction containing particles larger than openings in the U.S. 625 Mesh.

In some embodiments of the drying-type joint compound composition, the friction coefficient has been lowered by at least 5%.

In particularly preferred embodiments, the drying-type joint compound composition may comprise on a dry basis: about 50 wt % to about 95 wt % of the gypsum powder; about 0.5 wt % to about 15 wt % of the binder; about 1 wt % to about 10 wt % of the one or more clays; about 0.05 wt % to about 3 wt % of the cellulosic thickener; and about 0.1 wt % to about 1 wt % of the additive comprising one or more of the following: a biocide, a pigment, a fungicide, a dispersing agent, a humectant, a defoaming agent, a plasticizer, a dedusting agent, or any combination thereof.

In some embodiments, the drying-type joint compound composition may further comprise one or more of the following light-weight fillers: perlite, expanded perlite, coated expanded perlite, mica, hollow glass microspheres, talc, polyethylene hollow microspheres, ceramic microspheres, solid glass microspheres, plastic microspheres, or any mixture thereof. Preferably, one or more of the light-weight fillers may be used in an amount from about 0.5 wt % to about 25 wt % on a dry basis of the drying-type joint compound.

In particularly preferred embodiments, the drying-type joint compound composition may further comprise one or more of the following dedusting agents: a wax, oil, polyethylene glycol, glycerol, siloxane, or any combination thereof; and/or one or more of ASE and/or HASE rheological modifiers. The drying-type joint compound embodiments include those, wherein the binder is a latex binder with a high glass transition temperature (T_{g}).

In another aspect, this disclosure relates to a ready-mixed drying-type joint compound which comprises the drying-type joint compound composition according to this disclosure and water.

In yet another aspect, this disclosure relates to a method for optimizing a friction coefficient of a drying-type joint compound, the method comprising: grinding gypsum mineral fragments into gypsum powder with the median particle size distribution D50 of at least about 20 μm. The method may further comprise separating particles according to their sizes in a turbine, with a whizzer air separator, a cyclone, an elbow jet air classifier and/or passing the gypsum powder through a fine U.S. standard mesh and collecting a gypsum fraction retained on the sieve.

In yet another aspect this disclosure relates to a method for treating a seam between adjacent wallboard panels and/or for treating a wallboard panel surface, the method comprising:
i. filling the seam with a drying-type joint compound and/or applying the drying-type joint compound over the wallboard panel surface, the drying-type joint compound comprising:
   a) gypsum powder having the median particle size (D50) of at least about 20 μm;
   b) a binder;
   c) one or more clays;
   d) a cellulosic thickener;
   e) an additive; and
   f) water; and
ii. after the applied joint compound dries, sanding the dried joint compound.

### BRIEF DESCRIPTION OF THE DRAWINGS

FIG. 1 is a schematic side view of one embodiment of a system for measuring a friction coefficient for a joint compound according to this disclosure.

FIG. 2 is a chart reporting results of a comparative analysis comparing a friction coefficient in drying-type joint compounds comprising gypsum powder according to this disclosure in comparison to formulations comprising gypsum, calcium carbonate, or synthetic gypsum.

FIG. 3 is a chart reporting results of a comparative analysis comparing a friction coefficient in drying-type joint compounds comprising gypsum powder according to this disclosure in comparison to formulations which comprise various additives, such as dedusting agents and/or different binders.

### DETAILED DESCRIPTION

In this disclosure, “wt %” means percentage by weight. In this disclosure, all percentages and ratios are by weight, unless specifically stated otherwise.

In this disclosure, “about” means a value plus/minus 10%. For example, “about 100” means 100±10 and “about 200” means 200±20.

In this disclosure, the term “composition” may be used interchangeably with the term “mixture” or “formulation.” Compositions include dry powder formulations which do not comprise water or liquid components as well as compositions in liquid, slurry or paste form which comprise water and/or liquid components.

In this disclosure, “a dry joint compound composition” means that the composition does not contain aqueous water or liquid components. Preferably, the composition may be in powder form. However, a dry composition or dry mixture may have some moisture content and may contain compounds with bound water molecules.

In this disclosure, “dry component” means a component which does not comprise aqueous water or liquid additives. The dry component may have some moisture content and may contain bound water molecules.

In this disclosure “by wt % on a dry basis of the composition” means by weight of dry components, not including aqueous water or liquid components.

In this disclosure, the term “gypsum” may refer to any of the following: naturally mined gypsum (ore), landplaster and/or synthetic gypsum. Gypsum may also include gypsum which originate from a waste stream, as a bi-product, or a recycled material, such as dry wall. The term “gypsum” may be used interchangeably with the term “calcium sulfate dihydrate” or CaSO₄·2H₂O.

The term “synthetic gypsum” can be also referred to as “chemical gypsum,” or flue gas desulfurization (FGD) gypsum.

In this disclosure, the term “calcined gypsum” may be used interchangeably with calcium sulfate hemihydrate, stucco, calcium sulfate semi-hydrate, calcium sulfate half-hydrate, plaster of Paris, or CaSO₄·½H₂O.

When calcined gypsum (CaSO₄·½H₂O) is mixed with water into a slurry or paste, calcined gypsum hydrates and sets into a gypsum matrix. This setting reaction can be described by the following equation:

CaSO₄·½H₂O+3/2H₂O→CaSO₄·2H₂O

In this disclosure, the term “limestone” may be used interchangeably with calcium carbonate or CaCO₃.

In this disclosure, the median particle size of gypsum powder may be abbreviated as “D50.” The median particle size of gypsum, D50 may be measured by a laser diffraction (scattering) method, preferably using isopropyl alcohol as dispersant. D50 is the median diameter particle size with 50% of counted particles having larger diameters (sizes) and 50% of counted particles having smaller diameters (sizes). In this disclosure, measurements were performed on Horiba LA950V2 dynamic light scattering analyzer from HORIBA, Ltd. (Japan) using isopropyl alcohol as dispersant at room temperature of about 21° C. Particles in the gypsum powder according to this disclosure may be further characterized with D10 and D90 values. D10 is defined as a particle size on a particle size distribution curve below which 10% of particles have a smaller particle size and above which 90% of particles have a larger size. D90 is defined as a particle size on the particle size distribution curve below which ninety percent of particles have a smaller particle size and above which ten percent of particles have a larger particle size.

In this disclosure “a composition is substantially free of fine particles” means that the composition comprises less than about 5%, less than about 2%, or less than about 1% of fine particles, e.g., between about 0.01% to about 5% of fine particles having a size of about 5 μm, or smaller.

Natural gypsum for construction is traditionally processed in a method which includes excavating gypsum mineral from the earth crust, crushing the gypsum mineral into gypsum fragments, preferably to a size of 20-30 mm, and then grinding the gypsum fragments until gypsum powder with the median size distribution (D50) of about 15 μm is obtained, which is a preferred size of ground gypsum for construction formulations because the finer the grinding, the larger is the reaction surface of ground gypsum and the faster is the setting reaction of calcined gypsum. It was reported in U.S. Pat. No. 3,723,146 that having calcined gypsum that is substantially free of plus 32 micron particles improves significantly resistance to aging and produces a faster setting reaction. However, one of technical disadvantages of dry-type joint compounds which comprise gypsum is that these joint compounds are difficult to sand.

This disclosure provides a technical solution to this problem, wherein these inventors have unexpectedly discovered that a drying-type joint compound with a technically acceptable friction coefficient of about 1.25 or lower, preferably of about 1.20 or lower, and most preferably of about 1.15 or lower, can be obtained by controlling particle size distribution in gypsum during grinding and/or by subsequent fractionation of the gypsum powder according to particle sizes such that a gypsum powder is produced which has a D50 value of about at least 20 μm or greater, e.g. at least equal or greater than 24, 31, 62, or 78 μm. The gypsum powder preferably also has a D10 value greater than about 5 μm.

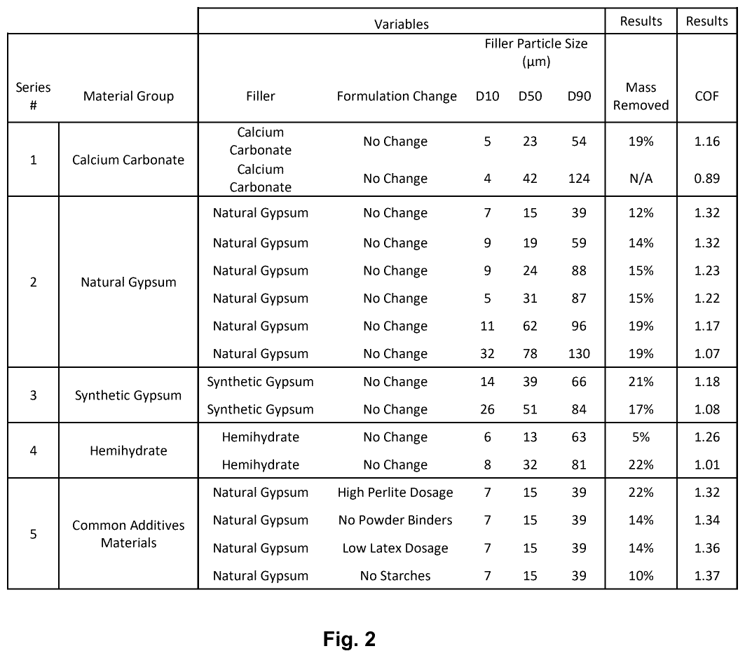

In one aspect, this disclosure relates to a drying-type joint compound composition containing gypsum powder with a particle size distribution optimized for lowering a friction coefficient of a drying-type joint compound. Preferably, the gypsum powder has D50 of about 20 μm or greater, e.g., of at least about 21 μm or greater, at least about 22 μm or greater, at least about 24 μm or greater, for example in the range from about 20 μm to about 80 μm, or in the range from about 21 μm to about 75 μm. In preferred embodiments, the gypsum powder also has a D10 greater than 5 μm, e.g., equal or greater than 6 μm, 7 μm, 8 μm, 9 μm, 10 μm or 11 μm. In some embodiments, the gypsum powder is substantially free of fine particles with a particle size ranging from about 0.1 μm to about 10 μm, or more preferably ranging from about 0.1 μm to about 5 μm. In preferred embodiments, the gypsum powder may also have a D90 equal or less than about 130 μm, e.g., equal or less than about 96 μm, 90 μm, 89 μm, 88 μm, 87 μm, 86 μm, or 85 μm. Embodiments of the gypsum powders according to this disclosure are listed in FIG. 2, including the powders in series 2, having the coefficient of friction 1.23, 1.22, 1.17 or 1.07. These gypsum powders have the following particle size distributions respectively: D10=9, D50=24 and D90=88; D10=5, D50=31 and D90=87; D10=11, D50=62 and D90=96; or D10=32, D50=78 and D90=130.

Before this disclosure, it was generally believed in the construction field that gypsum is not suitable even in small amounts as a filler for a drying-type joint compound in part because such drying-type joint compounds are more difficult to sand. In contrast to the general belief, it has been now unexpectedly found that a drying-type joint compound with a lowered friction coefficient can be prepared with a gypsum powder which has been produced such that production of fine particles is avoided during crushing/grinding and/or the ground gypsum powder has been fractionated according to particle sizes such that fine particles, including those in the range from about 0.1 μm to about 5 μm, have been removed from the gypsum powder.

In order to obtain the gypsum powder having the D50 value of 20 μm or greater, a person of skill may use a grinding machine. Examples of grinding machines include, but are not limited to, a ball mill, impact mill and/or a roller mill. Preferably, a tumbling mill grinding machine, or a ball mill can be used. One or more of the following parameters may be adjusted in order to produce the gypsum powder having the D50 value of 20 μm or greater: ball size distribution, mill speed, grinding aid ratio, ball filling ratio and grinding time. In some embodiments, after gypsum rock has been milled, a particle size fractionation can be conducted in a turbine or with a whizzer air separator which separate fine particles from the rest of gypsum powder.

Suitable gypsum particle fractionation techniques which can be used include, but are not limited, to inertia based, centrifugal, and/or residence time based techniques, such as turbines, whizzer air separators, cyclones which can control and remove a particulate matter from the gypsum powder according to particle size, elbow jet air classifiers which can classify gypsum particles into several products simultaneously based on the particle size.

In addition to a grinding procedure aiming at producing the gypsum powder having the D50 value of 20 μm or greater, a step of fractionation according to particle size may be also performed. The fractionation aiming at separation and removal of fine particles may be performed in a turbine, with a whizzer air separator, a cyclone, or an elbow jet air classifier. The size fractionation step may also include passing gypsum powder through a sieve such that only fine particles are passed through the sieve openings and these fine particles are thereby separated and removed from a gypsum powder fraction retained on the sieve.

In order to measure a particle size distribution in gypsum, a person of skill may use a particle size analyzer such as a dynamic light scattering analyzer such as for example as Horiba LA950V2 dynamic light scattering analyzer (Horiba, Japan) and isopropyl alcohol as dispersant.

In embodiments, the gypsum powder may be fractionated by using a U.S. standard Sieve 625 Mesh (20 μm openings), 450 Mesh (32 μm openings), wherein gypsum to be fractioned is passed through a U.S. 625 Mesh or 450 Mesh and the gypsum powder which is retained on the mesh is collected and is the gypsum powder according to this disclosure.

U.S. standard Mesh Size is defined as the number of openings in one square inch of a screen. U.S. 625 Mesh has 625 openings per one square inch, U.S. 450 Mesh has 450 openings per one square inch and U.S. 325 Mesh has 325 openings in one square inch. The gypsum powder according to this disclosure may be noted with a minus (−) or plus (+) sign. If the minus (−) sign is used, it denotes that particles in the gypsum powder are smaller than the mesh size. If the plus (+) sign is used, it denotes that most of particles in the gypsum powder are larger than the mesh size. For example, +450 mesh gypsum powder indicates that at least 90% of particles in the gypsum powder are larger than 32 μm. The same gypsum powder may be referred to as plus 32 μm gypsum powder.

In some preferred embodiments, the gypsum powder may substantially consist of at least 80% and preferably at least 90% of particles sizing in the range from about 350 μm to about 5 μm, and more preferably the gypsum powder may substantially consist of or consist of 90% or 80% of particles with sizes in the range from about 200 μm to about 5 μm.

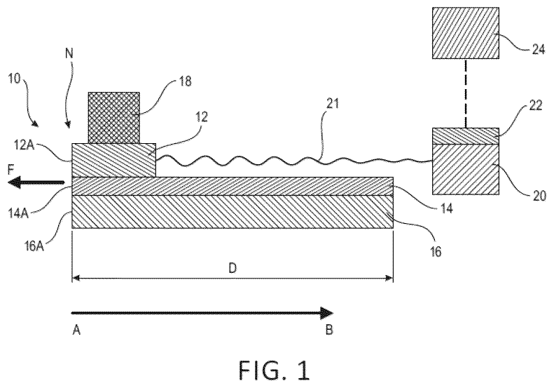

Referring to FIG. 1, in this disclosure, a friction coefficient (u) is defined as the ratio of the friction force (F) resisting a motion in direction from A to B of a sanding surface (12) in contact with a dried joint compound to be sanded (14), the dried joint compound (14) being applied over a surface (16), to the normal force (N) pressing the two surfaces (12 and 14) together, the normal force (N) being applied by a weight (18) pressing over the two surfaces (12 and 14) together. The friction coefficient (μ) is defined by formula (I):

$$μ = \frac{F}{N} ,$$

wherein F is the friction force and N is the normal force

In formula (I), F and N are measured in Newtons and accordingly, the friction coefficient (μ) has no measurement units.

Still referring to FIG. 1 which depicts a side view of one embodiment for a system for measuring a friction coefficient (μ), generally (10). The friction coefficient (μ) may be calculated by measuring the friction force (F) using the system (10) in which a joint compound to be tested is applied to a certain thickness, e.g., 0.62 mm thickness, over a surface (16), preferably the surface being a wallboard, and most preferably the wallboard being 4 inches by 12.25 inches panel. The applied drying-type joint compound is allowed to dry, thereby producing a dried joint compound (14) to be tested. Preferably, the joint compound (14) is applied on a 4″×12.25″ wallboard panel at a 0.62 mm thickness, with a 2.5″ width and a 12.25″ length.

A sanding surface (12) such as for example as sanding paper, preferably 150 grit sandpaper and most preferably 10×9 cm size 150 grit sandpaper is then placed over the dried joint compound (14) by aligning one an edge (14A/16A) of the dried compound to be sanded (14) with an edge (12A) of the sanding surface (12). A weight (18) of a known value, for example a 1500 g weight, is then placed over the sanding surface (12), pressing the two surfaces (12 and 14) together and generating normal force (N) in the direction shown with an error.

The sanding surface (12) is connected to a means (20) with a wire, rope or chain (21). A force is then applied to the sanding surface (12) by means (20) sufficient to drug the sanding surface (12) in direction from A to B over the dried joint compound surface (14) for a distance (D). The means (20) is connected to a force gauge (22). The force gauge (22) measures a resistance force (F) resisting a motion of the sanding surface (12) in direction from A to B. The force gauge (22) may be optionally in communication with a processor (24) which process force values received from the force gauge (22) and computes the friction coefficient (μ) of a sample according to formula (I).

One suitable system for measuring the friction coefficient (μ) includes a system and method for evaluating a joint compound specimen disclosed in U.S. Pat. No. 10,928,286, the entire disclosure of which is herein incorporated by reference.

Referring to FIG. 2, it reports friction coefficients for drying type joint compounds prepared with a filler comprising gypsum having D50 of about 15μ versus drying type joint compounds prepared with the gypsum powder according to this disclosure and having a D50 value of about 20μ or greater. As a control, samples in series 1 were prepared with calcium carbonate as a filler. As can be seen in FIG. 2, using gypsum having a D50 value of about 15 μm increases a friction coefficient unfavorably in comparison to a drying-type joint compound comprising calcium carbonate, from 1.16 to 1.32. This unfavorable increase in the friction coefficient cannot be remedied by adding various amounts of light-weight filler perlite (series 5) or by changing a formulation of a binder (series 5). In contrast, the gypsum powder according to this disclosure having a D50 value of at least 24 μm or greater produces a drying-type joint compound with a friction coefficient which is lower than that of a joint compound formulated with gypsum having D50 of 15 μm (series 2). A joint compound prepared with the gypsum powder according to this disclosure has an acceptable friction coefficient which is comparable or even lower than a friction coefficient of a joint compound prepared with calcium carbonate.

In some preferred embodiments, the friction coefficient of a joint compound formulated with the gypsum powder according to this disclosure has been lowered by at least about 5%, about 10% and more preferably by at least 15% and most preferably by at least 20% in comparison to a joint compound prepared with gypsum having the median particle size (D50) of about 15 μm.

Still referring to FIG. 2, it has been further unexpectedly found that synthetic gypsum can be obtained with a friction coefficient as low as 1.08 even with a powder in which D90 is 84.

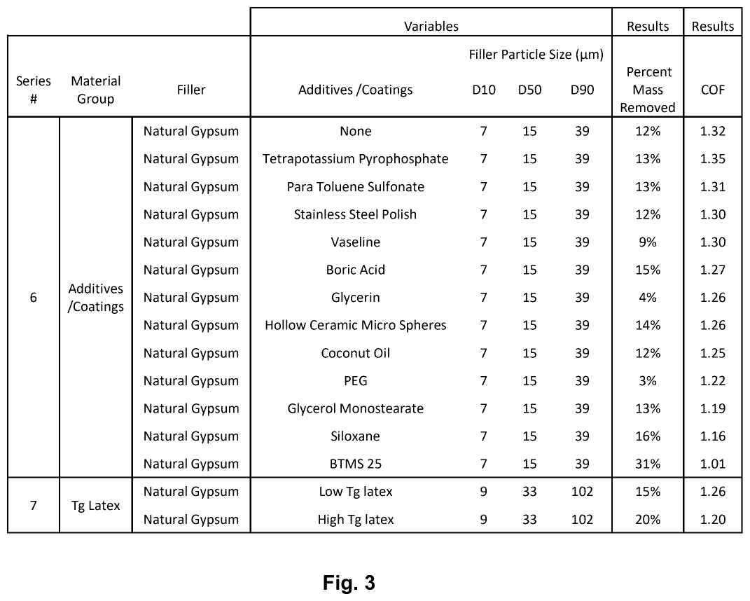

The drying-type joint compounds according to this disclosure, including those reported in FIG. 2 and FIGS. 3, may comprise from about 50 wt % to about 95 wt %, more preferably 55 wt % to 85 wt %, or 60 wt % to 75 wt % on a dry basis of the gypsum powder according to this disclosure. Thus, the gypsum powder can be used as a main filler and in large amounts because the friction coefficient has been optimized and is comparable or even lower than a friction coefficient of a drying-type joint compound which comprises calcium carbonate. In some embodiments, a drying-type joint compound may be prepared without calcium carbonate (limestone). In other embodiments, a drying-type joint compound may include calcium carbonate. In some other embodiments, a drying-type joint compound may be prepared with a combination of the gypsum powder and calcium carbonate. In some embodiments, the drying-type joint compound may comprise a mixture of the gypsum powder together with calcium carbonate in an amount ranging from 50 wt % to about 95 wt %, more preferably 55 wt % to 85 wt %, or 60 wt % to 80 wt % on a dry basis of the dry-type joint compound composition. Calcium carbonate to the gypsum powder may be used in a ratio ranging from 1:10 to 10:1 by weight.

Preferably, drying-type joint compounds according to this disclosure do not comprise calcined gypsum.

In addition to the gypsum powder and/or the gypsum powder and calcium carbonate as the main filler, some formulations of the dry-type joint compounds according to this disclosure may further comprise a second filler which may be preferably a light-weight filler comprising one or more of the following: perlite, expanded perlite, coated expanded perlite, mica, hollow glass microspheres, talc, polyethylene hollow microspheres, ceramic microspheres, solid glass microspheres, plastic microspheres, or any mixture thereof.

In embodiments, the light-weight fillers may be used in any suitable amounts, depending on the filler type. Preferably, from about 0.1 wt % to about 25 wt %, more preferably from about 0.5 wt % to about 20 wt % and most preferably from about 1 wt % to about 15 wt % of the light-weight filler on a dry basis may be used in at least some embodiments.

One particularly preferred light-weight filler is perlite which can be used as expanded perlite. Perlite may be coated or uncoated. Suitable coatings include silane or siloxane coatings, including as described in U.S. Pat. Nos. 4,454,267 and 4,525,388.

The drying-type joint compounds according to this disclosure may comprise at least one binder. Suitable binders include natural starches produced from plants, synthetic starches, polymeric binders, or any combination hereof. Non-limiting examples of starches are corn, wheat, and potato starch. Starches include those that have been chemically modified and/or pregelatinized.

Examples of suitable polymer binders include, but are not limited to, polyvinyl acetate, polyvinyl alcohol, acrylic emulsions, vinyl or styrene acrylic co-polymers, ethylene vinyl acetate co-polymer, polyacrylamide, or any combination thereof. In embodiments, one or more binders may be included in an amount ranging from about 0.5 wt % to about 15 wt %, preferably from about 4 wt % to about 10 wt %, on a dry basis of the joint compound composition.

In some preferred embodiments, a latex emulsion such as for example as ethylene vinyl acetate or polyvinyl acetate emulsion, may be used either alone or in combination with other polymer binders. In some embodiments, from about 1 wt % to about 10 wt %, or from about 1 wt % to about 5 wt % of a latex emulsion on a dry basis of the joint compound may be used.

As reported in FIG. 3, it has been further found that latex binders with a low glass transition temperature (low T_{g}) and/or a high glass transition temperature (high T_{g}) are suitable for drying-type joint compound compositions. However, using a latex binder with a high glass transition temperature may lower a friction coefficient further in the compositions according to this disclosure in comparison to the same compositions, but in which a latex binder with a low glass transition temperature has been used. Preferably, latex binders with high T_{g} include those having a T_{g} in the range from about 30 to about 60° C. Preferably, latex binders with low T_{g} include those having a T_{g} in the range from about 10 to about 25° C.

The drying-type joint compounds according to this disclosure may comprise at least one non-leveling agent, which may be attapulgite clay, bentonite, a starch, e.g., corn starch, or any combination thereof. Preferably, the drying-type joint compounds according to this disclosure comprise attapulgite clay and more preferably attapulgite clay in combination with kaolin clay. The non-leveling agents may be used in small amounts, for example in any amount ranging from about 0.5 wt % to about 10 wt %, or more preferably from about 1 wt % to about 5 wt % on a dry basis of the joint compound composition. In some preferred embodiments, attapulgite clay may be used in an amount from about 0.5 wt % to about 5.0 wt % and more preferably from about 1 wt % to about 3 wt %. In some embodiments, attapulgite clay may be used in combination with kaolin clay which may be used in small amounts of about 3 wt % or less, preferably from about 0.5 wt % to about 2 wt %, on a dry basis of the joint compound composition.

Drying-type joint compounds according to this disclosure may comprise one or more of cellulosic thickeners. Examples of suitable cellulosic thickeners include, but are not limited to, cellulose ethers in which the secondary hydroxyls of cellulose are replaced by ether groups, such for example as hydroxyethyl cellulose, hydroxypropyl methylcellulose, ethylcellulose, carboxymethyl cellulose, ethyl methylcellulose, among many others; as well as various cellulose-based gums, e.g., carrageenan, guar gum, and/or xanthan gum. The cellulosic thickener may be present in any amount ranging from about 0.05 wt % to about 3 wt %, preferably from about 0.1 wt % to about 2 wt % on a dry basis of the joint compound composition. In some embodiments, one or more cellulosic thickeners may be used in amount ranging from about 0.1 to about 0.5 wt % and more preferably from about 0.1 to about 0.4 wt % on a dry basis of the joint compound composition.

The drying-type joint compound compositions according to this disclosure may further comprise one or more low molecular weight polymeric rheology modifiers, including one or more of alkali-swellable (ASE) acrylic polymers and/or hydrophobically modified alkali swellable (HASE) acrylic co-polymers. The ASE polymeric rheology modifiers include co-polymers of methacrylic acid and acrylic ester in which thickening may be triggered by a change from low to high pH. The HASE polymeric rheology modifiers include co-polymers of acrylic acid and one or more of second associative monomers which may contain a hydrophilic chain segment linked with a terminal hydrophobic group. The ASE and/or HASE rheological modifiers may be used in small amounts, preferably from about 0.01 wt % to about 10 wt %, about 0.1 wt % to about 5.0 wt %, or about 0.1 wt % to about 1 wt % on a dry basis of the joint compound composition. In some embodiments, the ASE and/or HASE rheological modifiers may be used in an amount ranging from about 0.1 wt % to about 3 wt % and more preferably from about 0.5 wt % to about 2 wt % on a dry basis of the joint compound composition.

The drying-type joint compounds according to this disclosure may further comprise one or more of other additives, including, but not limited to, a biocide, a pigment, a fungicide, a dispersing agent, a humectant, a defoaming agent, a plasticizer, a dedusting agent, or any combination thereof. Some of the additives may be a polymeric additive selected from one or more of the following: a surfactant, redispersible powdered latex, dispersing agent, humectant, defoaming agent, a plasticizer, polyethylene oxide, a phospholipid, or any combination thereof. If present, any of these additives may be used in a small amount, such as for example as from about 0.1 wt % to about 2 wt % on a dry basis of the joint compound composition.

In some embodiments, the composition may comprise from about 0.1 wt % to about 0.5 wt % of a biocide and/or from about 0.1 wt % to about 5 wt %, more preferably from about 1.5 wt % to about 2.5 wt % of mica.

Particularly preferred additives include those which may be used to further decrease a friction coefficient of the drying-type joint compound according to this disclosure. The dedusting additives may include a wax, oil, polyethylene glycol (PEG), glycerol, or any combination thereof. As reported in FIG. 3, particularly preferred dedusting agents include, but are not limited to, coconut oil, glycerol monostearate, and/or siloxane. As shown in FIG. 3, these compounds may lower a friction coefficient of a drying-type joint compound comprising gypsum even with D50 of about 15 μm. Particularly suitable examples of glycerol include, but are not limited to, ethylene glycol, propylene glycol, diethyl glycol, or any combination thereof. Any of these dedusting agents may be used in an amount ranging from about 0.1 wt % to about 1 wt % on a dry basis of the joint compound composition.

In some embodiments, the drying-type joint compounds according to this disclosure may be prepared as a dry powder composition which is then mixed with water prior to use. Water can be added in any amount suitable to produce a paste-like consistency. Preferably, water may be used in a weight ratio of water to dry components of the joint compound in the range from about 1:6 to about 1:1, respectively.

In other embodiments, the drying-type joint compounds according to this disclosure may be prepared as ready-mixed paste formulations. In these embodiments, the dry components are premixed with water and allowed to be stored as a premixed composition. One embodiment of a ready-mixed joint compound according to this disclosure is listed in Table 1 below.

TABLE 1
Ready-Mixed Joint Compound Composition

| | | | Most |
|---|---|---|---|
| | | Percent | Preferred |
| | | Range | Percent |
| Raw Material | Percent (%) | (%) | Range (%) |
| Gypsum with D50 | 44.6% | 25.0-55.0% | 35.0-50.0% |
| at least 20 μm, | | | |
| optionally in | | | |
| combination with | | | |
| calcium carbonate | | | |
| Mica | 2.0% | 0.0-5.0% | 1.5%-2.5% |
| Perlite | 5.8% | 0.0-10.0% | 4.0-8.0% |
| Attapulgite Clay | 1.6% | 0.5-5.0% | 1.0-3.0% |
| Kaolin Clay | 0.8% | 0.0-3.0% | 0.5-2.0% |
| Cellulosic Thickener | 0.4% | 0.0-0.5% | 0.1-0.4% |
| Acrylic Rheological | 1.8% | 0.0-3.0% | 0.5-2.0% |
| Modifier | | | |
| Latex Emulsion | 1.0% | 0.0-5.0% | 1.0-3.5% |
| Polymeric additive | 0.4% | 0.0-2.0% | 0.1-0.5% |
| selected from one | | | |
| or more of the | | | |
| following: surfactant, | | | |
| redispersible | | | |
| powdered latex, | | | |
| dispersing agent, | | | |
| humectant, defoaming | | | |
| agent, a plasticizer, | | | |
| polyethylene oxide, | | | |
| a phospholipid or any | | | |
| combination thereof. | | | |
| Starch | 0.3% | 0.0-3.0% | 0.1-1.0% |
| Optionally, Biocide | 0.4% | 0.0-0.5% | 0.1-0.5% |
| Water | 40.9% | 35.0%-55.0% | 40.0%-50.0% |
| Total | 100.0% | 100.0% | 100.0% |

In another aspect, this disclosure relates to methods of using joint compounds according to this disclosure. The joint compounds according to this disclosure include all-purpose joint compounds, taping joint compounds, and finishing joint compounds and they can be used for finishing seams (joints) between adjacent wallboard panels and/or to prepare or repair a wallboard surface. After the drying-type joint compound is applied to a surface, the drying-type joint compound is allowed to dry. After the joint compound has sufficiently dried, it can be sanded, preferably dry sanded, but wet sanding and/or sponging can be also used. In embodiments, sanding can be performed with sandpaper, optionally with a vacuum attachment.

The joint compounds according to this disclosure may be used in any of the following applications among others: 1) repairing minor damages on a wallboard surface, e.g., holes, dents, and scares; and 2) preparing a wallboard surface wherein the joint compound can be applied over the surface as a skim coating. The joint compounds can be also used to finish wallboard panel joints and/or to mask corner beads, joint tape and fasteners.

We claim:

1. A drying-type joint compound composition comprising:
a) gypsum powder having the median particle size (D50) of at least about 20 μm;
b) a binder;
c) one or more clays;
d) a cellulosic thickener; and
e) an additive.

2. The drying-type joint compound composition of claim 1, wherein the median particle size (D50) is measured in a dynamic light scattering analyzer and wherein the drying-type joint compound composition when mixed with water and allowed to dry has a friction coefficient lower than a friction coefficient of a drying-type joint compound comprising gypsum having the median particle size (D50) of about 15 μm.

3. The drying-type joint compound composition of claim 1, wherein the gypsum powder has a D10 value equal or greater than 5 μm.

4. The drying-type joint compound composition of claim 1, wherein the gypsum powder is produced in a method which comprises removing fine particles from the gypsum powder.

5. The drying-type joint compound composition of claim 1, wherein the additive includes a polymeric additive selected from one or more of the following: a surfactant, redispersible powdered latex, dispersing agent, humectant, defoaming agent, a plasticizer, polyethylene oxide, a phospholipid, or any combination thereof.

6. The drying-type joint compound composition of claim 1, wherein the gypsum powder has the D50 value in the range from about 20 μm to about 80 μm.

7. The drying-type joint compound composition of claim 1, wherein:
the gypsum powder is in an amount ranging from about 50 wt % to about 95 wt % on a dry basis of the drying-type joint compound composition; or
the joint compound further comprises calcium carbonate, and wherein the gypsum powder together with calcium carbonate comprise from about 50 wt % to about 95 wt % on a dry basis of the dry-type joint compound composition; and calcium carbonate to fractionated gypsum is used in a ratio ranging from 1:10 to 10:1 by weight.

8. The drying-type joint compound composition of claim 1, wherein the gypsum powder being fractionated to remove fine particles, and wherein the gypsum powder does not comprise or comprises only less than 10% of fine particles which are smaller than 5 μm.

9. The drying-type joint compound composition of claim 1, wherein the gypsum powder being fractioned in a method which comprises: separating particles in the gypsum powder according to their sizes in a turbine, with a whizzer air separator, a cyclone, an elbow jet air classifier and/or by passing the gypsum powder through a U.S. 625 Mesh and collecting a gypsum fraction retained on the U.S. 625 Mesh, the retained gypsum fraction containing particles larger than openings in the U.S. 625 Mesh.

10. The drying-type joint compound composition of claim 2, wherein the friction coefficient has been lowered by at least 5%.

11. The drying-type joint compound composition of claim 1, wherein the drying-type joint compound composition comprises on a dry basis:
about 50 wt % to about 95 wt % of the gypsum powder;
about 0.5 wt % to about 15 wt % of the binder;
about 1 wt % to about 10 wt % of the one or more clays;
about 0.05 wt % to about 3 wt % of the cellulosic thickener; and
about 0.1 wt % to about 3 wt % of the additive comprising one or more of the following: acrylic rheological modifier, biocide, pigment, fungicide, dispersing agent, humectant, defoaming agent, plasticizer, dedusting agent, or any combination thereof.

12. The drying-type joint compound composition of claim 1, wherein the drying-type joint compound composition further comprises one or more of the following light-weight fillers: perlite, expanded perlite, coated expended perlite, mica, hollow glass microspheres, talc, polyethylene hollow microspheres, ceramic microspheres, solid glass microspheres, plastic microspheres, or any mixture thereof.

13. The drying-type joint compound composition of claim 12, wherein the one or more of the light-weight fillers are used in an amount from about 0.5 wt % to about 25 wt % on a dry basis of the drying-type joint compound.

14. The drying-type joint compound composition of claim 1, wherein the drying-type joint compound composition further comprises one or more of the following dedusting agents: a wax, oil, polyethylene glycol, glycerol, siloxane, or any combination thereof.

15. The drying-type joint compound of claim 1, wherein the binder is a latex binder with a high glass transition temperature (T_{g}).

16. The drying-type joint compound of claim 1, wherein drying-type joint compound further comprises one or more of ASE and/or HASE rheological modifiers.

17. A ready-mixed drying-type joint compound which comprises the drying-type joint compound composition of claim 1 and water.

18. A method for optimizing a friction coefficient of a drying-type joint compound, the method comprising:
grinding gypsum mineral fragments into gypsum powder with the median particle size distribution D50 of at least about 20 μm.

19. The method of claim 18, wherein the method further comprises processing the gypsum powder in a turbine, a whizzer air separator, a cyclone, or an elbow jet air classifier and collecting a gypsum powder fraction separated from fine particles.

20. A method for treating a seam between adjacent wallboard panels and/or for treating a wallboard panel surface, the method comprising:
i. filling the seam with a drying-type joint compound and/or applying the drying-type joint compound over the wallboard panel surface, the drying-type joint compound comprising:
a) gypsum powder having the median particle size (D50) of at least about 20 μm;
b) a binder;
c) one or more clays;
d) a cellulosic thickener;
e) an additive; and
f) water; and
ii. after the applied joint compound dries, sanding the dried joint compound.
